(19) United States
(12) Patent Application Publication
(10) Pub. No.: US 2010/0112676 A1
(43) Pub. Date: May 6, 2010

(54) ODOR CONTROL METHODS AND COMPOSITIONS

(76) Inventor: John D. Coates, Walnut Creek, CA (US)

Correspondence Address: HARNESS, DICKEY, & PIERCE, P.L.C, 7700 Bonhomme, Suite 400, ST. LOUIS, MO, 63105, US

(21) Appl. No.: 12/605,969

(22) Filed: Oct. 26, 2009

Related U.S. Application Data
(63) Continuation of application No. 11/512,726, filed on Aug. 30, 2006, now abandoned.
(60) Provisional application No. 60/713,210, filed on Aug. 31, 2005.

(51) Int. Cl. A62D 3/02

(52) U.S. Cl. 435/262

(57) ABSTRACT

This invention is directed generally to methods of controlling the odor of a biological material, and more particularly to methods comprising providing the biological material with an Fe(III)-reducing bacteria and a source of Fe(III). This invention also is directed generally to compositions and kits for controlling the odor of a biological material.

### CROSS-REFERENCE TO RELATED APPLICATIONS

This application is a continuation of U.S. patent application Ser. No. 11/512,726, filed Aug. 30, 2006, which claims the benefit of U.S. Provisional Patent Application No. 60/713,210, filed Aug. 31, 2005.

### FIELD

The present invention relates generally to methods and compositions for controlling the odor of a biological material.

### BACKGROUND

Control of odor associated with biological material is an important issue for a variety of industries worldwide. The sustainability, productivity, and/or profitability of industries such as the livestock and poultry industries depend on the extent to which odor emissions can be controlled. For example, odor control and management of swine waste have had a negative impact on swine production facilities throughout the US. Controlling odor becomes even more critical as facilities become larger or more confined.

Substances such as volatile fatty acids (VFAs), indoles, phenols, ammonia, volatile amine, and volatile sulfur compounds are among the malodorous components of animal waste such as swine waste. Each of these components can be microbially formed through the activity of fermentative bacteria that degrade the complex organics present in the waste.

Biological material such as swine waste can be treated microbially in aerobic activated sludge systems, however, these systems are energy intensive and there is a large production of microbial biomass (1.0-1.5 mol·mol waste treated) that also requires treatment and disposal. Traditional methanogenic systems are slow due to the low doubling times of the fatty acid-degrading syntrophic bacteria whose activity is central to the process. Alternative treatment systems based on sulfate-reducing bacteria or nitrate-reducing bacteria can produce noxious and toxic products (e.g., sulfide, nitrite, and nitrogen oxides). There remains, therefore, a need for convenient and effective methods and compositions for controlling odor of a biological material.

### SUMMARY

This invention is directed to a method of controlling the odor of a biological material. The method comprise providing the biological material with a source of Fe(III).

This invention also is directed to a method of controlling the odor of a biological material, the method comprising inoculating the biological material with an Fe(III)-reducing bacterium (FeRB).

This invention also is directed to a method of controlling the odor of a biological material, the method comprising inoculating the biological material with an FeRB and providing the biological material with a source of Fe(III).

This invention also is directed to a method of controlling the odor of a biological material, the method comprising inoculating the biological material with an FeRB and a source of Fe(III) sufficient to reduce the concentration of VFAs.

This invention also is directed to a composition useful for controlling the odor of a biological material, the composition comprising a source of Fe(III) in an odor-controlling effective total source of Fe(III) amount.

This invention also is directed to a composition useful for controlling the odor of a biological material, the composition comprising an FeRB.

This invention also is directed to a composition useful for controlling the odor of a biological material, the composition comprising an FeRB and a source of Fe(II) in an odor-controlling effective total source of Fe(III) amount.

This invention also is directed to a method of biodegrading a VFA in a biological material, the method comprising providing the biological material with a source of Fe(III).

This invention also is directed to a method of biodegrading a VFA in a biological material, the method comprising inoculating the biological material with an FeRB.

This invention also is directed to a method of biodegrading a VFA in a biological material, the method comprising inoculating the biological material with an FeRB and providing the biological material with a source of Fe(III).

This invention also is directed to a method of promoting methanogenesis in a biological material, the method comprising inoculating the biological material with an FeRB, wherein the biological material comprises a methanogen.

This invention also is directed to a method of enhancing methane production from the fermentation of biological material, the method comprising inoculating the biological material with an FeRB and a source of Fe(III) sufficient to enhance methane production.

This invention also is directed to a method of enhancing methane production from the fermentation of biological material, the method comprising providing the biological material with a source of Fe(III) sufficient to enhance methane production.

This invention also is directed to a method of modulating pH of a biological material, the method comprising inoculating the biological material with an FeRB, wherein pH of the biological material after the inoculating is higher than before the inoculating.

This invention also is directed to a method of modulating pH of a biological material, the method comprising providing the biological material with a source of Fe(III) wherein the pH of the biological material after the addition is higher than before the addition.

This invention also is directed to a kit comprising an FeRB for controlling the odor of a biological material and one or more user-accessible media carrying information that comprises instructions.

This invention also is directed to a bacterial strain having the designation strain Nu.

This invention also is directed to an inoculum of strain Nu.

This invention also is directed to a composition comprising strain Nu.

Advantages and benefits of the present invention will be apparent to one skilled in the art from reading this specification.

### BRIEF DESCRIPTION OF THE DRAWINGS

The skilled artisan will understand that the drawings, described below, are for illustration purposes only. The drawings are not intended to limit the scope of the present teachings in any way.

FIG. 1 illustrates a gel electrophoresis of PCR products obtained through amplification of the DNA extracted from the highest positive dilution tubes of the swine waste most probable number (MPN) series, using primers sets specific for Geobacteraceae, Geothrix, and Shewanella species. Lanes 1 & 14 are molecular weight markers; Lanes 2, 3, & 4 are pure culture controls of Geobacter metallireducens, Geothrix fermentans, and Shewanella algae respectively; Lanes 5, 6, & 7 are PCR products obtained from amplification of 16S rDNA from MPN tubes incubated with H₂ as the electron donor; Lanes 8, 9, & 10 are PCR products obtained from amplification of 16S rDNA from MPN tubes incubated with lactate as the electron donor; Lanes 11, 12, & 13 are PCR products obtained from amplification of 16S rDNA from MPN tubes incubated with acetate as the electron donor.

FIG. 2 illustrates the phylogenetic tree of the 16S rDNA sequence dataset resulting from distance analysis using the Jukes-Cantor correction. The same topology was obtained using either parsimony or maximum likelihood and was based on 636 sequence characters.

### DETAILED DESCRIPTION

It has been found in accordance with this invention that Fe(III) reduction in a biological material such as swine waste can be surprisingly effective in rapidly removing the malodorous compounds present in the material. Without being held to a particular theory, it is believed that microbial Fe(III) reduction can be an energetically favorable process. FeRB (i.e. Fe(III)-reducing bacteria) have a diverse metabolism and many pure culture examples exist that can completely oxidize straight and branched chain fatty acids, and aromatic organics without the need for the activity of the rate-limiting syntrophic bacteria (Coates et al. (1995) Arch. Microbial. 164: 406-413; Lovley et al. (2003) Nature Rev Microbial 1:35-44). The respiratory end-product of microbial Fe(III) (i.e. ferric iron) reduction is FOIL) (i.e. ferrous iron), which is nontoxic and can be recycled after abiotic re-oxidation through its reaction with O₂. In addition, added iron can abiotically react with sulfur compounds such as malodorous HS— ions forming non-odor-causing metal sulfide precipitates.

The term “biological material” herein refers to any material comprising organic matter. The biological material may comprise an odorous compound such as, for example, a VFA. It is contemplated that the methods and compositions of the present invention may be useful for a variety of biological material. Illustrative biological materials contemplated by the present invention include human and non-human waste such as, for example, livestock and poultry waste. The biological material can be waste that is present in a storage facility system such as a solid, liquid, or slurry system, for example, a primary or secondary lagoon.

In various embodiments, the present invention provides a method of controlling the odor of a biological material, such method comprising providing the biological material with a source of Fe(III).

The term “controlling the odor” herein refers to maintaining or decreasing the level or amount of odor that emanates from a biological material. Without being held to a particular theory, it is believed that biological material such as swine waste contains high concentrations of soluble branched and straight chain volatile fatty acids (VFAs) and monoaromatics, as well as, sulfur containing compounds released as a result of the hydrolytic activity of bacteria. Various compounds have been identified as the key causative agents of swine waste odor including acetate, propionate, butyrate, isobutyrate, isovalerate, valerate, hexanoate, heptanoate, phenol, p-cresol, skatole, indole, and ammonia. The characteristic odor is primarily associated with the VFA content especially butyrate, isobutyrate, valerate, and isovalerate.

The source of Fe(III) can be any iron-providing material, which can include carbonyl iron, iron salts, chelated iron, encapsulated iron, iron complexes, and mixtures thereof. Illustrative sources of Fe(III) contemplated by this invention include ferric chloride, ferric citrate, ferric nitrilotriacetic acid (Fe(III)-NTA), ferric hypophosphite, ferric albuminate, ferric oxide saccharate, ferric ammonium citrate, heme, ferric trisglycinate, ferric nitrate, ferric sulfate, ferric aspartate, ferric ascorbate, ferric oxide hydrate, ferric pyrophosphate soluble, ferric hydroxide saccharate, ferric manganese saccharate, ferric subsulfate, ferric ammonium sulfate, ferric sesquichloride, ferric choline citrate, ferric manganese citrate, ferric quinine citrate, ferric sodium citrate, ferric sodium edetate, ferric formate, ferric ammonium oxalate, ferric potassium oxalate, ferric sodium oxalate, ferric peptonate, ferric manganese peptonate, ferric acetate, ferric fluoride, ferric phosphate, ferric pyrophosphate, ferric fumarate, ferric succinate, ferrous hydroxide, ferrous nitrate, ferrous carbonate, ferric sodium pyrophosphate, ferric tartrate, ferric potassium tartrate, ferric subcarbonate, ferric glycerophosphate, ferric saccharate, ferric hydroxide saccharate, ferric manganese saccharate, ferric sodium pyrophosphate, ferric hydroxide, ferric oxyhydroxide, polysaccharide-iron complex, methylidine-iron complex, ferric diethylenetriamine, phenanthrolene iron complex, p-toluidine iron complex, iron-dextran complex, iron-dextrin complex, iron-sorbitol-citric acid complex, iron porphyrin complex, iron phtalocyamine complex, iron cyclam complex, dithiocarboxy-iron complex, desferrioxamine-iron complex, bleomycin-iron complex, ferrozine-iron complex, iron perhaloporphyrin complex, alkylenediamine-N,N-disuccinic acid iron(III) complex, hydroxypyridone-iron(III) complex, aminoglycoside-iron complex, transferrin-iron complex, iron thiocyanate complex, porphyrinato iron(III) complex, ferric hydroxypyrone complexes, ferric succinate complex, ferric chloride complex, ferric glycine sulfate complex, ferric aspartate complex, ferritin, and combinations thereof.

In some embodiments, the method further comprises inoculating the biological material with an FeRB.

The term “inoculating” herein refers to introducing something (e.g., microorganisms) into an environment. For example, microorganisms could be inoculated into a field comprising animal waste by spraying, injection, or planting of microbes or materials that have been contacted with the microbes, etc. Inoculation may introduce microbes into one or more specific locations in an environment, or it may disperse microorganisms throughout the environment.

The term “Fe(III)-reducing bacteria (FeRB)” herein refers to one or more bacteria that are able to couple the oxidation of an electron donor to the reduction of Fe(III) to Fen. FeRB represent a very diverse group both phenotypically and taxonomically and demonstrate a broad degradative capacity. Without being held to a particular theory, it is believed that in addition to the oxidation of simple fatty acids and alcohols, many important environmental contaminants such as aromatic hydrocarbons, halogenated solvents, and chlorinated benzenes can be degraded under Fe(III)-reducing conditions. Several pure culture isolates of Fe(III)-reducing bacteria are known to oxidize long chain fatty acids, aromatics such as toluene and benzoate, and dehalogenate chlorinated solvents such as tetrachloromethane and tetrachloroethylene. Non-limiting examples of FeRB include bacteria belonging to the family Geobacteracea, Deferribacteraceae, Acidobacteriaceae, and Alteromonadaceae.

In various embodiments, the FeRB comprises at least one member of Geobacteraceae.

In some embodiments, the FeRB comprises a member belonging to a family selected from the group consisting of Geobacteracea, Deferribacteraceae, and Acidobacteriaceae.

In other embodiments, the FeRB comprises at least one of Geobacter metallireducens, Geobacter humireducens, Geobacter sulfurreducens, Geobacter grbiciae, Geothrix fermentans, Geovibrio ferrireducens, and Geobacter strain NU.

In some embodiments, the FeRB comprises Geobacter strain NU.

In some embodiments, the biological material comprises animal waste. In other embodiments, the animal waste comprises swine waste.

In various embodiments, the source of Fe(III) is provided to the biological material in an amount effective for controlling the odor.

In other embodiments, the source of Fe(III) is provided to the biological material in an amount sufficient to promote oxidation of a VFA in the biological material.

In some embodiments, the source of Fe(III) is selected from ferric chloride, ferric citrate, ferric-nitrilotriacetic acid (Fe(III)-NTA), other iron salts, and mixtures thereof.

In various embodiments, the source of Fe(III) is an insoluble amorphous Fe(III)-(hydr)oxide.

In other embodiments, the VFA is selected from acetate, propionate, butyrate, isobutyrate, isovalerate, valerate, or mixtures thereof.

In various embodiments, the present invention provides a method of controlling the odor of a biological material, such method comprising inoculating the biological material with an FeRB, such as an FeRB as described above.

In some embodiments, the method further comprises providing the biological material with a source of Fe(III), such as a source as described above.

In one embodiment, the source of Fe(III) is provided in a total amount that is effective for controlling the odor of the biological material. In another embodiment, the source is provided to the biological material in an amount sufficient to promote oxidation of a VFA in the material.

In other embodiments, the present invention provides a method of controlling the odor of a biological material, such method comprising inoculating the biological material with an FeRB and providing a source of Fe(III). The FeRB and the source of Fe(III) are as described above.

In one embodiment, the source of Fe(III) is provided in a total amount that is effective for controlling the odor of the biological material. In another embodiment, the source is provided to the biological material in an amount sufficient to promote oxidation of a VFA in the material.

In some embodiments, the present invention provides a method of controlling the odor of biological material, such method comprising inoculating the biological material with an FeRB and a source of Fe(III) sufficient to decrease the concentration of VFAs. The FeRB and source of Fe(III) are as described above.

In further embodiments, the present invention provides a composition useful for controlling the odor of a biological material. The composition comprises a source of Fe(III) as described above.

In one embodiment, the source is present in the composition in an odor-controlling effective total source of Fe(III) amount. In another embodiment, the source is present in the composition in an amount sufficient to promote oxidation of a VFA present in the biological material.

In various embodiments, the VFA is as described above.

In some embodiments, the composition further comprises a source of Fe(III) as described above, the source being present in the composition in an odor-controlling effective total source of Fe(III) amount.

In other embodiments, the present invention provides a composition useful for controlling the odor of a biological material, such a composition comprising an FeRB as described above.

In some embodiments, the present invention provides a composition useful for controlling the odor of a biological material, such a composition comprising an FeRB and a source of Fe(III) in an odor-controlling effective total source of Fe(III) amount.

The FeRB and the source of Fe(III) in the composition are as described above.

In further embodiments, the present invention provides a method of biodegrading a VFA in a biological material, such method comprising providing the biological material with a source of Fe(III) as described above.

In some embodiments, the method further comprises inoculating the biological material with an FeRB.

The term “biodegrading” herein refers to metabolism of a compound such as a VFA. Without being held to a particular theory, biodegradation can be based upon microbial respiration. In respiration, microbes can gain energy from the consumption (oxidation) of electron donors coupled to the utilization (reduction) of electron acceptors. Compounds present in a biological material can either serve as electron donors or electron acceptors. For example, microbial biodegradation of a VFA in an Fe(III)-reducing system can comprise oxidation of the VFA coupled to the utilization of Fe(III). In this case, Fe(III) can be the electron acceptor, while the VFA is the electron donor which may be oxidized by this process.

In some embodiments, the source of Fe(III) and the FeRB are as described above.

In other embodiments, the VFA is as described above.

In some embodiments, the source is provided to the biological material in an odor-controlling effective total source of Fe(III) amount.

In other embodiments, the source is provided to the biological material in an amount sufficient to promote oxidation of a VFA.

In still further embodiments, the present invention provides a method of biodegrading a VFA in a biological material, such as method comprising inoculating the biological material with an FeRB.

In some embodiments, the method further comprises providing the biological material with a source of Fe(III).

In some embodiments, the source of Fe(III) and the FeRB are as described above.

In other embodiments, the VFA is as described above.

In some embodiments, the source is provided to the biological material in an odor-controlling effective total source of Fe(III) amount.

In other embodiments, the source is provided to the biological material in an amount sufficient to promote oxidation of a VFA.

In some embodiments, the present invention provides a method of biodegrading a VFA in a biological material, such a method comprising inoculating, the biological material with an FeRB and providing the biological material with a source of Fe(III).

In certain embodiments, the source of Fe(III) and the FeRB are as described above.

In other embodiments, the VFA is as described above.

In some embodiments, the source is provided to the biological material in an odor-controlling effective total source of Fe(III) amount.

In other embodiments, the source is provided to the biological material in an amount sufficient to promote oxidation of a VFA.

In some embodiments, the present invention provides a method of promoting methanogenesis in a biological material, such a method comprising inoculating the biological material with an FeRB, wherein the biological material comprises a methanogen.

The term “methanogen” herein refers to any microbe that produces methane gas as a by-product of metabolism.

The term “methanogenesis” herein refers to the production of methane gas by biological processes that are carried out by methanogens.

The term “promoting methanogenesis” herein refers to either 1) increasing the total amount of methane produced by the methanogenic population in a biological material or 2) maintaining or increasing the rate of methane production by a methanogen in a biological material.

The terms “syntrophically”, “syntrophism”, and “syntrophy” herein refer to symbiotic cooperation between at least two metabolically different types of microbes which depend on each other for degradation of a certain substrate, typically for energetic reasons. Without being held to a particular theory, it is believed that in the absence of a suitable electron acceptor some FeRB can grow syntrophically with a H₂-using bacterium, for example, a methanogen.

In some embodiments, the method further comprises providing the biological material with a source of Fe(III) as described.

In other embodiments, the FeRB is as described above.

In some embodiments, the source is provided to the biological material in a methanogenesis-promoting effective total source of Fe(III) amount.

In other embodiments, the source is provided to the biological material in an amount sufficient to promote oxidation of a VFA as described above.

In some embodiments, the present invention provides a method of enhancing methane production from the fermentation of biological material, such a method comprising inoculating the biological material with an FeRB and a source of Fe(III) sufficient to enhance methane production. The FeRB and the source of Fe(III) are as described above.

In other embodiments, the present invention provides a method of enhancing methane production from the fermentation of biological material, the method comprising providing the biological material with a source of Fe(III) sufficient to enhance methane production.

In some embodiments, the present invention provides a method of modulating the pH of a biological material. The method comprises inoculating the biological material with an FeRB, wherein the pH of the biological material after the inoculation is higher than before the inoculation. The FeRB is as described above.

In other embodiments, the method further comprises providing the biological material with a source of Fe(III) as described above.

In some embodiments, the source is provided in a pH-modulating effective total source of Fe(III) amount.

In other embodiments, the source is provided in an amount sufficient to promote oxidation of a VFA as described above.

In other embodiments, the pH of the biological material at a time after the inoculation can be at least about 6, illustratively about 6 to about 8.5, or about 6.2 to about 7.8, or about 6.5 to about 7.5, or about 6.8 to about 7.2.

In some embodiments, the present invention provides a method of modulating the pH of a biological material, such a method comprising providing the biological material with a source of Fe(III), wherein the pH of the biological material after the providing is higher than before the providing. The source of Fe(III) is as described above. In one embodiment, the source is provided in a pH-modulating effective total source of Fe(III) amount. In another embodiment, the source of Fe(III) is provided in a total amount sufficient to increase the pH of the biological material to at least about 6, illustratively about 6 to about 8.5, or about 6.2 to about 7.8, or about 6.5 to about 7.5, or about 6.8 to about 7.2.

In various embodiments, the present invention provides a kit. The kit comprises an FeRB for controlling the odor of a biological material and one or more user-accessible media carrying information that comprises instructions.

In some embodiments, the kit comprises an FeRB as described above.

In other embodiments, the kit further comprises a source of Fe(III) as described above.

In some embodiments, the present invention provides a bacterial strain having the designation strain NU.

In other embodiments, the present invention provides an inoculum of strain NU.

In some embodiments, the present invention provides a composition comprising strain NU.

### EXAMPLES

The following examples are merely illustrative, and do not limit this disclosure in any way.

### Example 1

This example illustrates the degradation of VFAs by FeRB as determined by growth of pure FeRB cultures containing VFA.

Active pure cultures of Geobacter metallireducens, G. humireducens, G. sulfurreducens, G. grbiciae, Geothrix fermentans, Shewanella algae, and Geovibrio ferrireducens were screened for their ability to degrade individual VFAs. All FeRB were maintained in anoxic, defined freshwater medium previously described (Coates et al. (2001) Int J Sys Evol Microbiol 51:581-588; Coates et al. (1999) Int J Sys Bac 49:1615-1622) with individual VFAs as the sole electron donor (10 mM acetate, 5 mM propionate, 5 mM butyrate, 5 mM isobutyrate, and 5 mM valerate) or with 0.1 ml of an artificial swine waste mix comprising 40 mM acetate, 40 mM propionate, 30 mM butyrate, 30 mM isobutyrate, 30 mM isovalerate, 30 mM valerate, 1.16 mM hexanoate, 0.15 mM heptanoate, 0.3 mM phenol, 0.3 mM p-cresol, 0.29 mM skatole, 0.3 mM indole, and 0.129 mM ammonia using standard anaerobic culturing techniques previously described (Balch et al. (1979) Microbiol Rev 43:260-296; Hungate (1969) Methods Microbiol. 3B:117-132; Miller et al. (1974) Appl Microbiol 27:985-987). Fe(III) chelated with nitrilotriacetic acid (Fe(III)-NTA) (10 mM) was used as the sole electron acceptor. Anoxic medium was prepared under a headspace of N₂—CO₂ (80:20, v/v) by boiling to remove dissolved O₂ prior to dispensing under an N₂—CO₂ (80:20, v/v) gas phase into anaerobic pressure tubes or serum bottles and sealing with thick butyl rubber stoppers. Freshly prepared medium was sterilized by autoclaving at 121° C. for 15 min and culture incubations were carried out at 30° C. in the dark. Positive growth was determined by transferability of the culture and Fe(III) reduction.

Organic acid concentrations were analyzed by HPLC with UV detection (Shimadzu SPD-10A) using a HL-75H⁺ a cation exchange column (Hamilton #79476). The eluent was 0.016N H₂SO₄ at a flow rate of 0.4 ml·min⁻¹. Biogas analysis was performed on 1 ml aliquots of headspace gas collected with a N₂ flushed airtight syringe. The biogas samples were injected into a gas chromatograph equipped with a Porapak N 80-100 mesh column (12′×⅛″ diameter stainless steel) and a thermal conductivity detector (TCD). Chromatography was performed with an N₂ mobile phase at a flowrate of 20 ml·min⁻¹ and a column temperature of 65° C. The injector and detector temperatures were 180 and 200° C., respectively. The complete removal of valerate and isovalerate was limited by the depletion of the available Fe(UI) in these experimental bottles.

As shown in Table 1, all of the Geobacter species tested except Geobacter sulfurreducens were capable of oxidizing some or all of the compounds tested. In addition to the Geobacter species, other genera of known Fe(III)-reducers including Geovibrio ferrireducens and Geothrix fermentens also degraded the VFAs. In contrast, Shewanella algae did not oxidize any of the compounds tested, which is consistent with the fact that Shewanella species are incomplete oxidizers and use a relatively limited range of organic electron donors.

TABLE 1
The ability of FeRBs to degrade the VFAs
associated with the odor of swine waste.

| FeRB | Butyrate | Isobutyrate | Valerate |
|---|---|---|---|
| Geobacter metallireducens | + | + | + |
| Geobacter humireducens | + | + | + |
| Geobacter sulfurreducens | − | − | − |
| Geobacter grbiciae | + | + | + |
| Shewanella algae | − | − | − |
| Geothrix fermentans | + | + | − |
| Geovibrio ferrireducens | − | + | + |

+ and − denote growth and no growth, respectively, as determined by transferability of the culture and Fe(III) reduction.

Several of the Geobacter species could utilize the VFAs individually, as shown in Table 2 for Geobacter grbicium grown on 5 mM isovalerate with 10 mM Fe(III)-NTA as the sole electron acceptor. Control cells were grown in the absence of isovalerate.

TABLE 2
Growth and Fe(III) reduction of G. grbicium

| | | Hour 0 | Hour 1 | Hour 2 | Hour 3 | Hour 4 |
|---|---|---|---|---|---|---|
| Fe(II) | Control | 2.36 | nd | 1.84 | 4.63 | 4.17 |
| (mM) | Isovalerate | 1.54 | 3.16 | 3.40 | 8.07 | 7.71 |
| Cells | Control | 75000 | 2.0e+05 | 5.5e+05 | 7.5e+05 | 6.0e+05 |
| (per ml) | Isovalerate | 87500 | 4.0e+06 | 6.8e+06 | 1.4e+07 | 1.5e+07 |

nd = not determined

As shown in Table 3 for Geobacter metallireducens, several of the Geobacter species could utilize the VFAs as a mixture of all thirteen of the components in the artificial swine waste mix described above. Cells were grown with 10 mM Fe(III)-NTA as the electron acceptor with or without (control group) 0.1 ml swine mix. Chromatographic analysis of the VFAs of the Geobacter metallireducens culture revealed complete degradation of acetate, propionate, butyrate, and isobutyrate and the partial removal of valerate and isovalerate (data not shown).

TABLE 3
Growth and FE(III) reduction of G. metallireducens

| | | Day 1 | Day 3 | Day 5 | Day 11 | Day 12 | Day 13 | Day 15 |
|---|---|---|---|---|---|---|---|---|
| Fe(II) | Control | 0.51 | 0.82 | 0.73 | 1.52 | 1.16 | 0.88 | 0.99 |
| (mM) | Swine mix | 0.94 | 1.23 | 1.38 | 5.45 | 8.67 | 12.82 | 15.80 |
| Protein | Control | 0.02 | 0.00 | nd | 0.05 | 0.017 | nd | 0.018 |
| (mg/ml) | Swine mix | 0.013 | 0.033 | nd | 0.074 | 0.122 | nd | 0.123 |

nd = not determined

These studies established that phylogenetically diverse FeRB can utilize VFAs and their activity could potentially be stimulated in animal waste.

### Example 2

This example illustrates the presence of an FeRB microbial community indigenous to animal waste lagoons as determined by most probable number (MPN) technique.

Swine waste was collected from primary waste treatment lagoons from below the surface at the sediment interface and placed into clean canning jars that were filled to capacity and sealed with airtight screw caps. Freshly collected waste was used to inoculate the previously described (Bruce et al. (1999) Environ Microbial 1:319-331) basal medium in triplicate amended with 2,6-anthraquinone disulfonate (AQDS) (5 mM) as the electron acceptor and hydrogen (101 kPa), acetate (2 mM), lactate (2 mM), or palmitate (1 mM) respectively as the sole electron donor. AQDS was used as the electron acceptor to allow easy identification of positives by the change in color from light-tan in the oxidized form to bright-red color in the reduced form. Concentrations of AQDS were determined calorimetrically at 450 nm as described previously (Coates et al. (1998) Appl Environ Microbial 64:1504-1509). MPN series with hydrogen as the sole electron donor were also amended with 0.1 mM acetate as an appropriate carbon source. Sodium pyrophosphate (1% wt/vol) was added to the first dilution tubes in the MPN series to detach the cells from the sediment particles. All MPN tubes were incubated at room temperature in the dark for 60 days prior to analysis. Previous studies demonstrated that all tested AQDS-reducing bacteria were also capable of dissimilatory Fe(III) reduction. Positives in the MPN series were identified visually by color change of the medium from tan to red as the AQDS was reduced. Cell growth was determined by direct microscopic cell counts or by protein assay as previously described (Bruce et al. (1999) Environ Microbial 1:319-331).

As shown in Table 4, there is a microbial community indigenous in the swine waste lagoon sediments capable of reducing AQDS. The microbial counts were similar regardless of the electron donor used although the hydrogenotrophic population (2.31±1.33×10⁵) was slightly higher than the organotrophic acetate-oxidizing FeRB (9.33+4.17×10⁴).

TABLE 4
Counts of dissimilatory FeRB in swine waste.

| Electron Donor | Concentration | | Most Probable Number (cells · g⁻¹) |
|---|---|---|---|
| H₂ | 101 | kPa | (2.31 + 1.33) × 10⁵ |
| Acetate | 10 | mM | (9.33 + 4.17) × 10⁴ |
| Lactate | 10 | mM | (7.49 + 3.35) × 10⁴ |
| Palmitate | 10 | mM | (9.33 + 4.17) × 10⁴ |

These studies established that FeRB capable of using diverse substrates were present in swine waste. The different electron donors in the present study were selected to reflect the dominant electron donors available in natural environments and ensure that both complete- and incomplete-oxidizers were represented. Previous studies demonstrated that anaerobic trophic groups of respiratory bacteria such as sulfate-reducing bacteria and FeRB generally fall into two categories, those that completely oxidize multicarbon compounds to carbon dioxide and those that incompletely oxidize multicarbon organics to acetate. In general, all of the incomplete-oxidizers also use H₂ or lactate as suitable electron donors. H₂ and acetate are the primary end-products of the biodegradation of complex organics in anoxic environments and as such are considered to be the most important electron donors for anaerobic microbial respiration.

### Example 3

This example illustrates the presence of bacteria of the family Geobacteraceae in animal waste lagoons as determined by polymerase chain reaction (PCR) amplification using 16S ribosomal DNA (rDNA) primers.

DNA was extracted from the highest dilution tubes of the MPN series showing positive growth. Cell pellets harvested from 1.5 ml of the respective culture broths were prepared for PCR by adding 40 μl sterile H₂0 and 5 μl chloroform, and lysing the cells by heating at 95° C. for 10 min. PCR analysis to detect Geobacteraceae, Geathrix and Shewanella species was performed using 16S rDNA primer sets specific for each of these species as previously described (Coates et al. The Biogeochemistry of Aquifer Systems, p. 719-727. In Hurst et al., Manual of Environmental Microbiology, 2nd ed. ASM Press, Washington, D.C.).

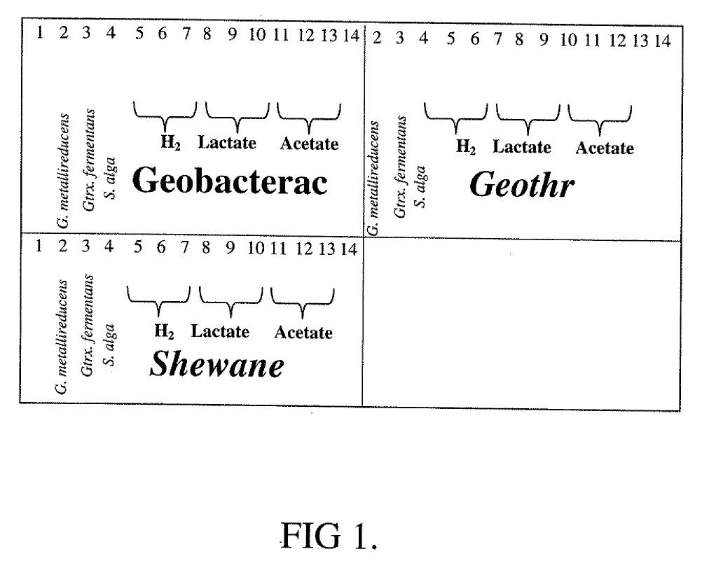

As shown in FIG. 1, members of the family Geobacteraceae were the dominant FeRB present regardless of the electron donor. No PCR products were observed with primer sets specific for Shewanella or Geothrix species. Analysis of the Fe(III) and total iron content of freshly collected samples from the swine waste lagoons indicated that all of the iron (1.4 mmols/L) was in the reduced form (i.e. Fe(II)) and was thus not available to the FeRBs for growth.

These results demonstrate the importance of the family Geobacteraceae in Fe(III)-reducing environments and are consistent with the findings of several previous studies. Further, while the animal waste contains FeRB, their activity may be limited by availability of Fe(III). Although there is a large diversity of mesophilic organisms capable of growth by dissimilatory Fe(III) reduction, previous studies have demonstrated that in most environments the predominant species and most readily isolated strains belong to the family Geobacteraceae in the delta subclass of the Proteobacteria and usually belong to the Geobacter genus. FeRBs have been isolated that represent the alpha, beta, gamma, and epsilon subclasses of the Proteobacteria as well as those forming novel lines of descent in the bacterial domain.

### Example 4

This example illustrates the isolation and characterization of an FeRB strain from animal waste lagoons.

Enrichments for FeRBs were established with freshly collected swine waste from swine lagoons. Acetate (10 mM) was used as the sole electron donor with Fe(III)-NTA (10 mM) as the sole electron acceptor. After two weeks incubation at 30° C., several of the enrichments were visually positive for Fe(III) reduction (color change from translucent orange to colorless with the presence of a white precipitate). One highly enriched culture was obtained by continual transfer over several weeks (10% inoculum) into fresh medium with acetate (10 mM) and Fe(III)-NTA (10 mM).

Small colonies were apparent on the surface of the agar plates after one week of incubation. The visible colonies ranged from 1 to 2 mm in diameter and were pink in color surrounded by a clear halo in the orange colored agar. Several of the pink colonies were selected for isolation and were transferred into fresh media amended with Fe(III)-NTA (10 mM) and acetate (10 mM). A new Fe(III)-reducing organism, which is designated as strain NU, was isolated by plating the active culture on medium solidified with 2% (wt/vol) noble agar and incubating at 30° C. in the dark under anaerobic conditions.

16S rDNA sequences were generated as previously described (Achenbach et al. (2001) Int J Syst Evol Microbiol 51:527-533; Coates et al. (1999) Appl Environ Microbiol 65:5234-5241). Sequence entry and manipulation was performed with the MacVector 7.2.2 sequence analysis software program for the Macintosh (Oxford Molecular). Sequences of select 16S rRNAs were downloaded from the Ribosomal Database Project (Maidak et al. (2000) Nucl Acids Res 28:173-174) and Genbank (Benson et al. (1998) GenBank. Nucl Acids Res 26:1-7) into the computer program SeqApp (Gilbert (1993) SeqApp, Version 1.9a157 Biocomputing Office, Biology Dept., Indiana University, Bloomington, Ind.). FeRB bacterial 16S rDNA sequences were manually added to the alignment using secondary structure information for accurate sequence alignment. Distance, parsimony, and maximum likelihood analysis of the aligned sequences was based on analysis of 636 base pairs and was performed using PAUP*4.0b10 (Swofford (1999) PAUP*: Phylogenetic Analysis Using Parsimony (and other methods), 4.0. Sinauer Associates, Sunderland, Mass. ed. Smithsonian Institution, Washington, D.C.). Bootstrap analysis was conducted on 100 replications using a heuristic search strategy to assess the confidence level of various clades. GenBank accession numbers for the sequences are as follows: Trichlorobacter thiogenes (AF223382); Geobacter sp. CdA-2 (Y19190); Geobacter sp. CdA-3 (Y19191); Geobacter chapelleii (U41561); Pelobacter propionicus (X70954); Geobacter sulfurreducens (U13928); Geobacter hydrogenophilus H2 (U28173); Geobacter metallireducens (L07834); Geobacter pelophilus (U96918); Geobacter humireducens (AY187306); and Desulfuromonile tiedjei (M26635).

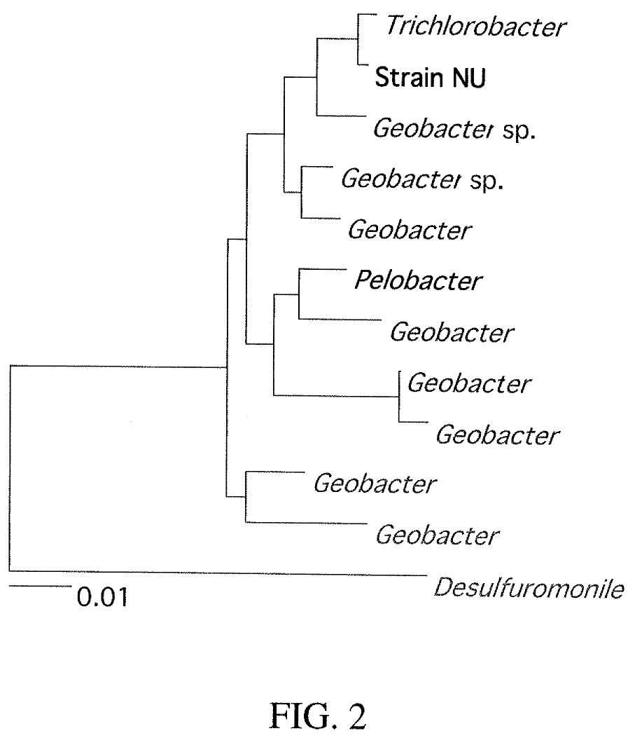

Strain NU is a complete-oxidizing, non-fermentative, gram-negative, obligate anaerobe (data not shown). Analysis of the partial sequence of the 16S rRNA gene placed strain NU in the Geobacteraceae family in delta subclass of the Proteobacteria with its closest relative being Trichlorobacter thiogenes. This is illustrated in FIG. 2.

Physiological characterization of this organism demonstrated that it could oxidize the individual VFAs listed in the artificial swine waste mix above coupled to dissimilatory Fe(III) reduction (data not shown). As shown in Table 5, strain NU grew and reduced Fe(III) quite rapidly in undiluted raw swine waste. This organism grew optimally in the raw swine waste amended with 100 mM Fe(III). Dilution of the swine waste or increase in the Fe(III) concentration resulted in a decrease in the rate of Fe(III) reduction. Analysis of the VFA concentration of the inoculated waste indicated that strain NU utilized the VFA in order of molecular size, starting with the least complex, acetate (data not shown). After six days of incubation in excess of 65% of the initial acetate and 28% of the initial propionate was removed at which point the organism became limited for an electron acceptor as it had reduced all of the available Fe(III) source.

TABLE 5
Fe(III) reduction of Strain Nu

| | | Day 0 | Day 2 | Day 4 | Day 6 |
|---|---|---|---|---|---|
| Fe(II) (mM) | Stock swine mix + | 6.3 | 19.5 | 89.0 | 117.0 |
| | 1 ml Fe(III) | | | | |
| | Stock swine mix + | 7.5 | 9.3 | 10.2 | 13.4 |
| | 5 ml Fe(III) | | | | |
| | *Dilute swine mix + | 5.5 | 10.8 | 17.7 | 22.6 |
| | 1 ml Fe(III) | | | | |

*Dilute swine mix = 10 fold dilution of stock swine mix.

These studies established that strain NU can biodegrade odor-causing components of animal waste.

### Example 5

This example illustrates the decrease in malodorous components of animal waste by FeRB as determined by measuring VFA content of animal waste treated with Fe(III) and/or FeRB.

Freshly collected waste from primary lagoon was dispensed in 1 L aliquots into three 2 L bottles under an aerobic headspace and sealed with thick butyl rubber stoppers. Bottles were inoculated (10% by volume) with an active culture and amended with various amounts of Fe(III)-oxide or protein. One of the prepared bottles was inoculated with an active acetate-oxidizing Fe(III)-reducing culture of strain NU and amended with approximately 100 mM amorphous Fe(III)-oxide (group B), one bottle was merely amended with approximately 100 mM amorphous Fe(III)-oxide (group A), and the third bottle was unamended/uninoculated (group C). Results were compared against uninoculated controls with and without FOB) amendments. All bottles were incubated in the dark at 30° C. Liquid samples were collected at various intervals for analysis of VFA, Fe(III), and total iron content using techniques known in the art. Fe(II) concentrations were determined colorimetrically by the ferrozine assay after HCl extraction as previously described (Lovley et al. (1988) Appl Environ Microbiol 54:1472-1480).

As shown in Table 6, added Fe(III) was rapidly reduced within the first three weeks of the five week incubation in both the strain NU-inoculated (group B) and uninoculated (group A) samples.

TABLE 6
Ferrous and total iron content of treated swine waste

Fe(II)
(% of total iron content)

| | A | B |
|---|---|---|
| Week 0 | 32.8 | 30.2 |
| Week 1 | 56.0 | 81.0 |
| Week 2 | 97.0 | 96.0 |
| Week 3 | 100.0 | 100.0 |
| Week 4 | 89.0 | 100.0 |
| Week 5 | 92.0 | 90.0 |

HPLC analysis of the swine waste throughout the incubation indicated that strain NU with Fe(III) supplementation had an effect on the VFA content. The results are shown in Table 7. During the first week of incubation the total VFA content in all samples increased from an initial average concentration of 33 mM. The total VFA content in the untreated samples (group C) rapidly and continuously increased throughout the five weeks of the incubation to achieve a maximum total VFA concentration of greater than 100 mM with a net increase of greater than 68 mmoles L⁻¹ VFA. This was likely due to the activity of fermentative bacteria degrading the complex organics present in the waste that exceeded the ability of the indigenous syntrophic and methanogenic populations to remove the products of fermentative metabolism. In contrast to the untreated samples (group C), both of the treated samples (groups A and B) showed a net decrease in the total VFA content after the five-week incubation. The uninoculated samples amended with Fe(III) (group A) showed the largest increase in the total VFA content after the first week reaching a maximum of almost 66 mM.

TABLE 7
Total VFA concentration in treated and untreated swine waste.

| Time | Total VFA (mM) | | |
|---|---|---|---|
| (wk) | A | B | C |
| 0 | 33.74 | 32.39 | 36.94 |
| 1 | 65.66 | 46.6 | 50.46 |
| 2 | 50.14 | 37.62 | 64.96 |
| 3 | 42.58 | 32.82 | 103.38 |
| 4 | 36.23 | 20.78 | 91.33 |
| 5 | 32.07 | 5.33 | 100.44 |

As shown in Table 8, at the initiation of the experiment, the VFA content in the swine waste of each bottle (groups A-C) was dominated by acetate, which represented an average of almost 42% of the total VFA content. After the first week, the total VFA content in the uninoculated samples amended with Fe(III) (group A) was dominated by acetate and propionate representing 50% and 33% of the total VFA content, respectively. During the weeks following initiation of the experiment, the total VFA content in the Fe(III)-amended samples continuously decreased to 32 mM and was dominated by propionate (70% of total VFA content). In the case of the samples inoculated with strain NU and amended with Fe(III) (group B), there was an initial increase in total VFA during the first week, which was primarily the result of a rapid increase in the propionate concentration. This was followed by a rapid and continuous removal of VFAs during the next several weeks to achieve a total VFA concentration of less than 5.5 mM after five weeks of incubation. The final VFA content was composed of almost equimolar amounts of acetate (1.40 mM), propionate (1.57 mM) and isobutyrate (1.64 mM). After five weeks incubation no unpleasant odor could be detected in these samples (group B), while a pungent odor was still obvious in the FOB) amended (group A) and untreated control (group C). The VFA content after the five-week incubation was dominated by acetate and propionate, which represented 47% and 35% of the total VFA content, respectively.

TABLE 8
VFA content of treated and untreated swine waste.

| | | Week 0 | Wk 1 | Wk 2 | Wk 3 | Wk 4 | Wk 5 | Wk 6 | Wk 7 |
|---|---|---|---|---|---|---|---|---|---|
| Acetate | A | 14.6 | 32.9 | 15.3 | 3.86 | 1.2 | 4.3 | 4 | 4.21 |
| (mM) | B | 14.11 | 18.9 | 5.3 | 1.31 | 5.7 | 1.4 | 5.1 | 11.2 |
| | C | 14.4 | 23 | 25.5 | 45.7 | 44.5 | 47.67 | 43.4 | 47.8 |
| Propionate | A | 7.21 | 21.5 | 25.25 | 29.6 | 28 | 22.36 | 16.5 | 19 |
| (mM) | B | 7.16 | 20.42 | 25.33 | 23.4 | 11.04 | 1.57 | 3 | 7.42 |
| | C | 7.94 | 16.81 | 25.3 | 35.2 | 31.5 | 34.73 | 33.2 | 37.9 |
| Butyrate | A | 2.2 | 2.87 | 2.3 | 3.68 | 1.49 | 1.38 | 1.47 | 2.62 |
| (mM) | B | 1.92 | 2.04 | 1.86 | 2.46 | 1.26 | 0.4 | 0.92 | 1.41 |
| | C | 2.45 | 3.33 | 4.26 | 5.19 | 3.52 | 4.23 | 4.5 | 7.22 |
| Isobutyrate | A | 2.09 | 2.07 | 0.81 | 0.87 | 0.26 | 0 | 0 | 0 |
| (mM) | B | 3.2 | 1.95 | 2.68 | 1.79 | 1.72 | 1.64 | 2 | 0 |
| | C | 3.96 | 0.57 | 0.73 | 1.49 | 1.48 | 1.79 | 0.95 | 2.24 |
| Valerate | A | 4.58 | 3.61 | 4.35 | 1.28 | 1.06 | 0.58 | 0 | 0 |
| (mM) | B | 3.63 | 1.46 | 0.57 | 1.5 | 0.13 | 0 | 0 | 0 |
| | C | 4.63 | 3.87 | 5.98 | 9.15 | 6.94 | 7.86 | 7.76 | 12.2 |
| Isovalerate | A | 3.06 | 2.71 | 2.13 | 3.29 | 4.22 | 3.45 | 2.18 | 1.29 |
| (mM) | B | 2.37 | 1.83 | 1.88 | 2.36 | 0.93 | 0.32 | 0.14 | 0.12 |
| | C | 3.56 | 2.88 | 3.19 | 6.65 | 3.39 | 4.16 | 5.99 | 13.1 |

These studies establish that FeRB systems for removing VFA and/or controlling odor can be developed in waste storage systems through seeding with an appropriate form of Fe(III) as the terminal electron acceptor and/or inoculation with an appropriate FeRB such as Geobacter strain NU.

### Example 6

This example illustrates the increase in methane levels in swine waste treated with Fe(III) and/or FeRB as determined by measuring methane gas.

The study is as described in Example 5. Headspace samples were collected at various intervals for methane analysis. Methane analysis was performed on 1 ml aliquots of headspace gas collected with a N₂ flushed airtight syringe. The biogas samples were injected into a gas chromatograph equipped with a Porapak N 80-100 mesh column (12′×⅛″ diameter stainless steel) and a thermal conductivity detector (TCD). Chromatography was performed with an N₂ mobile phase at a flowrate of 20 ml·min⁻¹ and a column temperature of 65° C. The injector and detector temperatures were 180 and 200° C., respectively.

As shown in Table 9, methane levels in the Fe(III)-supplemented samples (group A) and Fe(III)-supplemented samples inoculated with strain NU (group B) were greater than that of the untreated samples (group C). This effect was particularly evident once the Fe(III) in the treated samples was depleted after the initial three weeks incubation.

TABLE 9
Methane production in treated and untreated swine waste

| | Methane (mM) | | |
|---|---|---|---|
| | A | B | C |
| Week 0 | 0.37 | 0.06 | 0.24 |
| Week 1 | 21.81 | 25.91 | 18.96 |
| Week 2 | 40.67 | 48.53 | 34.74 |
| Week 3 | 46.01 | 52.49 | 36.09 |
| Week 4 | 59.18 | 83.24 | 46.03 |
| Week 5 | 85.20 | 124.01 | 57.68 |

Without being held to a particular theory, it is believed that in the absence of a suitable electron acceptor some FeRB can grow syntrophically with a H₂-using bacterium. The results herein suggest that in the treated swine waste, strain NU and the indigenous Fe(III)-reducing populations were metabolizing the VFAs coupled to FOE) reduction during the first three weeks of incubation. Once the Fe(BI) was depleted, these organisms switched to syntrophic metabolism, which can explain the continued metabolism of VFAs and methane production after Fe(III) was used.

### Example 7

This example illustrates the change in pH of animal waste after treatment with FeRB and/or Fe(BI).

The study is as described in Example 5. Liquid samples were collected at various intervals for analysis of pH using standard techniques known in the art.

As shown in Table 10, the pH of the untreated samples became acidic during the first week of incubation as a result of the rapid buildup of VFAs. In the treated samples, the pH remained relatively constant at circum neutral values throughout the five-week incubation.

TABLE 10
pH in treated and untreated swine waste

| | pH | | |
|---|---|---|---|
| | A | B | C |
| Week 0 | 7.05 | 7.00 | 6.81 |
| Week 1 | 6.82 | 6.92 | 6.77 |
| Week 2 | 6.69 | 6.95 | 6.13 |
| Week 3 | 6.85 | 6.92 | 6.11 |
| Week 4 | 7.00 | 7.01 | 6.30 |
| Week 5 | 6.98 | 7.16 | 5.35 |

Without being held to a particular theory, it is believed that the degradation of complex organic material under methanogenic conditions can be dependent on stable environmental conditions such as pH to sustain the activity of methanogens and slow-growing syntrophic populations. The inhibitory effect of pH can be enhanced by VFAs. As the pH decreases, the concentration of the undissociated form of the acid (HA) can increase relative to the ionized form (A). Undissociated short-chain organic acids can readily diffuse across biological membranes and dissipate the proton motive force.

As shown in Tables 8 and 9 above, Fe(III) supplementation with or without inoculation with strain NU kept total VFA concentrations much lower than that observed in the untreated samples. The concentrations of the undissociated form of VFAs in the treated samples with and without inoculation peaked during the first three weeks of incubation (2.3 and 1.9 mM, respectively) and then declined to less than 1 mM after seven weeks. Most of the time, these values were higher than those shown to inhibit acetoclastic methanogenesis and propionate degradation in acclimated sludge, and cause unstable operating conditions in sludge digestors. However, the concentration of undissociated acids was lower than in the untreated samples, which steadily increased from an initial value of about 1.3 mM to a final value of 8.7 mM after 7 weeks. The continued degradation of VFA, which prevented large changes in the pH plus the increase population levels of fatty acid degraders due to Fe(III) supplementation and inoculation with strain NU may explain the large and continued production of methane after Fe(III) was depleted.

Methods described herein utilize laboratory techniques well known to skilled artisans and can be found in laboratory manuals such as Sambrook, J., et al., Molecular Cloning: A Laboratory Manual, 3rd ed. Cold Spring Harbor Laboratory Press, Cold Spring Harbor, N.Y. (2001); Spector, D. L. et al. and Cells; A Laboratory Manual, Cold Spring Harbor Laboratory Press, Cold Spring Harbor, N.Y. (1998); and Harlow, E.

All references cited above are incorporated herein by reference in their entirety.

The words “comprise”, “comprises”, and “comprising” are to be interpreted inclusively rather than exclusively.

What is claimed is:

1. A method of biodegrading a volatile fatty acid (VFA) in a biological material that includes a methanogenic microbe that produces methane gas as a by-product of metabolism, where the VFA serves as an electron donor that may be subject to oxidation, the method comprising:
(a) treating the biological material with a source of Fe(III) that serves as the terminal electron acceptor in a process of reduction from Fe(III) to Fe(III); and
(b) inoculating the biological material with an Fe(III)-reducing bacteria (FeRB) that is able to couple the oxidation of an electron donor to the reduction of the source of Fe(III) to Fe(III),
wherein said biological material is treated with a source of Fe(III) in a sufficient amount that is effective to remove substantially all VFA during oxidation of the VFA from the biological material such that the FeRB does not become limited for an electron acceptor due to depletion of Fe(III) during oxidation of the VFA, to thereby promote continuous removal of VFA so as to remove substantially all the VFA content in the biological material whereby the treating of the biological material with the source of Fe(III) and the inoculating of the biological material with the FeRB results in an increase in methane levels in the biological material as compared to a methane level of the biological material prior to the treating and inoculating.

2. The method of claim 1 wherein the inoculating the biological material with the FeRB comprises inoculating a volume of the biological material with the FeRB in an amount of 10 percent by volume of said biological material and wherein the treating of the biological material comprises adjusting the volume of the biological material with at least 100 mM of the Fe(III) source.

3. The method according to claim 2 wherein the FeRB comprises at least one member of Geobacteraceae that is able to couple the oxidation of an electron donor to the reduction of a source of Fe(III) that is selected from the group consisting of ferric chloride, ferric citrate, and ferric nitrilotriacetic acid.

4. The method according to claim 2 wherein the FeRB comprises at least one bacteria selected from the group consisting of Geobacter metallireducens, Geobacter humireducens, Geobacter sulfurreducens, Geobacter grbiciae, Geothrix fermentans, Geovibrio ferrireducens, Geobacter strain NU.

5. The method according to claim 4 wherein the FeRB comprises Geobacter strain NU.

6. The method of claim 1 wherein the source of Fe(III) is provided in an amount effective to control an odor in the biological material.

7. The method of claim 1 wherein the source of Fe(III) is provided in an amount sufficient to promote oxidation of the VFA in the biological material.

8. The method of claim 1 wherein the source of Fe(III) is selected from the group consisting of ferric chloride, ferric citrate, ferric nitrilotriacetic acid, other Fe⁺³ salts, and mixtures thereof.
